(19) United States
(12) Patent Application Publication
(10) Pub. No.: US 2020/0391489 A1
(43) Pub. Date: Dec. 17, 2020

(54) Recyclable Packaging Laminate with Improved Heat Resistance for Sealing

(71) Applicant: Constantia Pirk GmbH & Co. KG, Pirk (DE)

(72) Inventors: Thami Lamtigui, München (DE); Achim Grefenstein, Altrip (DE)

(21) Appl. No.: 16/492,041

(22) PCT Filed: Jun. 19, 2019
(86) PCT No.: PCT/EP2019/066275

§ 371 Date: Sep. 6, 2019

(30) Foreign Application Priority Data
Jun. 21, 2018 (AT) A50500/2018

(51) Int. Cl. B32B 27/08; B32B 27/30; B32B 27/20; B32B 27/34; B32B 27/16

(52) U.S. Cl. CPC B32B 27/08; B32B 2435/02; B32B 27/20; B32B 27/34; B32B 27/16; B32B 2250/03; B32B 2250/04; B32B 2250/05; B32B 2250/24; B32B 2250/40; B32B 2307/308; B32B 2255/10; B32B 2255/205; B32B 2255/26; B32B 2439/70; B32B 2439/46; B32B 27/306

(57) ABSTRACT

A recyclable packaging laminate with an externally arranged sealing layer having a polyethylene content of at least 80 vol %, with a substrate layer having a polyethylene content of at least 60 vol %, and with a thermal stabilization layer. The thermal stabilization layer is arranged externally opposite to the sealing layer, and the substrate layer is arranged between the sealing layer and the thermal stabilization layer, wherein the thermal stabilization layer is produced from ethylene-vinyl alcohol copolymer, and the thickness of the thermal stabilization layer constitutes up to 10% of the total thickness of the packaging laminate, but no more than 10 μm.

### TECHNICAL FIELD

The present teaching relates to a recyclable packaging laminate and a method for producing such a packaging laminate in which an externally arranged sealing layer comprising a polyethylene content of at least 80 vol % is bonded with a substrate layer comprising a polyethylene content of at least 60 vol % and with a thermal stabilization layer, whereby the thermal stabilization layer is arranged externally opposite the sealing layer, and the substrate layer is arranged between the sealing layer and the thermal stabilization layer.

### BACKGROUND

Within the packaging industry, packaging laminates are used which, depending on the application, are intended to exhibit a variety of characteristics. In most cases, packaging laminates of this kind are plastic films which are produced using extrusion processes, co-extrusion processes (in both cases using both flat film and blown film processes) or lamination processes (combining individual layers by means of a lamination adhesive, also as extrusion lamination), or mixtures thereof. Layers which do not consist of plastic, for example a layer made of aluminum or paper, can also be integrated into the packaging laminate. In most cases, the packaging laminate comprises an external sealing layer in order to process the packaging laminate into a desired form of packaging, for example a pouch, sack or bag, etc., by means of thermosealing. In another application, a packaging laminate can also be designed as shrink film which, depending on the application, can also be produced as a sealable yet unprinted design, for example when packaging larger quantities of meat.

A typical requirement for a packaging laminate is that of a barrier function against water vapor, oxygen, and/or aroma. To meet this requirement, the packaging laminate normally includes a barrier layer made of aluminum or of a suitable barrier polymer, for example ethylene-vinyl alcohol copolymer (EVOH) or polyamide (PA). A barrier layer, for example one made of EVOH, is conventionally arranged between two additional laminate layers since moisture (even atmospheric humidity) can deteriorate the barrier properties of the EVOH.

In addition, further layers may be included in order to provide the packaging laminate with desired properties such as toughness, rigidity, shrinkability, tear resistance, etc.

In order to enable easy processing of the packaging laminate, the packaging laminate should not warp or curl, for which reason symmetrical layer structures are conventionally used.

It is furthermore known to alter the properties of the packaging laminate by means of a uni-directional or bi-directional orientation. One form of orientation can take place by means of the extrusion process, for example when using a multiple bubble extrusion process. But conventionally, said orientation takes place only after the extrusion process, when the packaging laminate is elongated in the machine direction (in the longitudinal direction of the packaging laminate) and/or in a transverse direction (normal to the longitudinal direction). This orientation of the packaging laminate is primarily able to improve rigidity, tensile strength, and toughness. In addition, the shrinking properties of the packaging laminate can be achieved by the orientation, but also that otherwise opaque materials such as HDPE to become more transparent after being elongated.

For reasons of recyclability, it is also desirable to produce packaging laminates consisting of a single material whenever possible, e.g., packaging laminates only made of polyethylene-based materials, or mixing polyethylene-based plastics with acceptably low quantities of plastics that are compatible in terms of recyclability.

A sealing layer is typically formed from a polyolefin, normally polypropylene (PP) or polyethylene (PE) of various densities (LLDPE, LDPE, MDPE, or HDPE) as well as mixtures thereof, in which context other materials may obviously also be suitable for the sealing layer. For sealing, for example when producing packaging such as bags, the folded packaging laminate is compressed between two temperature-controlled sealing jaws. A packaging laminate is also compressed between temperature-controlled sealing jaws when using lidding films to close containers. As a result, the sealing medium melts, thus forming a bond between the adjacent sealing layers after the cooling process. In this context, it is clearly desirable to reduce the sealing time as much as possible since doing so can increase the throughput of a packaging machine. This can be achieved by, e.g., higher sealing temperatures, since the heat will be conducted inwards toward the sealing point more rapidly thereby. However, the maximum possible sealing temperature clearly depends on the outermost layer of the packaging laminate facing the sealing jaws, more particularly on the melting point of this material. For example, HDPE has a melting point of about 130° C. Assuming a minimum necessary sealing temperature of 80° C. (or more likely higher), it becomes evident that the sealing window (the temperature range within which sealing must take place) is narrow. This makes performing the process on the one hand more difficult and on the other hand increases the achievable sealing times.

One response to this would be using materials having greater thermal stability, for example polyester (PET), in the outermost layer. However, the resulting problem is that a packaging laminate made of PE materials comprising a PET layer cannot be recycled. Also an admixture of propylene (PP) to the HDPE in the external layer would increase thermal stability. However, the recyclability of the laminate would be negatively affected in this case as well. A mixture of HDPE and a cycloolefin copolymer (COC) would likewise increase thermal stability and, given the addition of a small quantity of COC, would still be acceptable in terms of recyclability. However, COCs are expensive, thus reducing interest in their use in packaging laminates for which cost plays a quite decisive role.

Known from EP 764 519 A1 is a deep-drawable laminate comprising an external EVOH layer that is intended to form a barrier layer and provide the laminate with thermal stability for the deep-drawing process. The EVOH layer is intended to simultaneously prevent the laminate from adhering to the deep-drawing mold. Moisture deteriorates the barrier properties of EVOH in a known manner, for which reason EVOH is not conventionally used in an external layer. Therefore, due to the barrier properties desired of the EVOH layer, the EVOH layer in the laminate of EP 764 519 A1 is relatively thick, comprising from 15-30% of the total thickness of the laminate in order to nevertheless achieve sufficient barrier performance. Given that EVOH is an expensive material, the deep-drawable laminate becomes much more expensive as a result.

### SUMMARY

One object of the present teaching is to specify a recyclable packaging laminate that exhibits improved thermal stability for sealing, and to specify a method for producing such a packaging laminate.

This object is achieved by the thermal stabilization layer being produced from ethylene-vinyl alcohol copolymer, and by the thickness of the thermal stabilization layer constituting up to 10%, preferably up to 5%, of the total thickness of the packaging laminate, but no more than 10 μm. Surprisingly, it was determined that such a thin layer made of EVOH on the outside of the packaging laminate can significantly increase the thermal stability of the packaging laminate for sealing without impairing recyclability. As a result, the sealing temperature can be significantly increased despite this small thickness, thus shortening sealing times and making the sealing process more flexible since the sealing window also expands considerably thereby. The sealing process can thereby become faster, more reliable, and more flexible without the external EVOH layer adhering to the sealing jaw or undesirable visible marks being left on the packaging laminate.

In addition, a bonding layer can be advantageously arranged between the substrate layer and the thermal stabilization layer in order to enhance the adhesive bonding in the packaging laminate.

The packaging laminate can be produced by means of co-extrusion, by means of lamination, or by a combination thereof, thus expanding the options for the production process.

### BRIEF DESCRIPTION OF THE DRAWINGS

The present teaching is explained in greater detail hereinafter with reference to FIGS. 1 to 5, which show exemplary, schematic, and non-restrictive advantageous embodiments of the present teaching.

FIG. 1 shows a first embodiment of a packaging laminate according to the present teaching,

FIG. 2 shows a second advantageous embodiment of a packaging laminate according to the present teaching,

FIG. 3 shows a further advantageous embodiment of a packaging laminate according to the present teaching,

FIG. 4 shows a pouch made of a packaging laminate according to the present teaching produced by means of sealing, and

FIG. 5 shows the closing of a container made of a packaging laminate according to the present teaching by means of sealing a lidding film.

### DETAILED DESCRIPTION

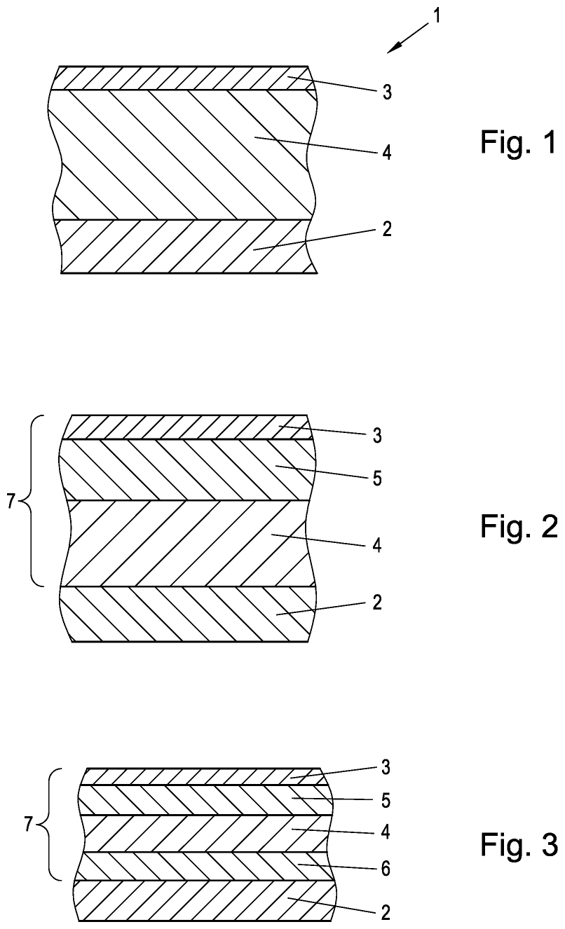

FIG. 1 shows a packaging laminate 1 according to the present teaching comprising two external layers, a sealing layer 2 and a thermal stabilization layer 3, with a substrate layer 4 arranged therebetween.

The substrate layer 4 primarily consists of polyethylenes (PE) and of materials that are compatible thereto in terms of recyclability. Advantageously, the substrate layer 4 has a PE content, preferably polyethylene (PE) in high-density form (HDPE), of at least 60 vol %, preferably at least 70 vol %, and particularly preferably at least 80 vol % of PE content. The PE content may in this case approach 100 vol %, but a PE content of 100 vol % is rarely reached because of typical additives in the packaging laminates 1 (e.g., slip additives, antiblock additives, coloring agents, filling agents, etc.). The remainder (apart from potential additives) is a compatible polyolefin material that does not impair recyclability. In principle, any type of polyethylene may be regarded as a compatible polyolefin material, in particular also ethylene copolymers such as ethylene-vinyl acetate copolymers (EVA), methacrylic acid esters (EMA), ethylene/acrylic acid copolymers (EAA), or ethylene butyl-acrylate copolymers (EBA). Similarly, polypropylene (PP) or a cycloolefin copolymer (COC) in an amount not more than 20 vol % may also be used as compatible materials. In the case of PP, a polypropylene random copolymer comprising ethylene as a comonomer (typically from 5 to 15%), a polypropylene copolymer comprising ethylene, or a polypropylene homopolymer, that is sufficiently compatible with linear types of PE, e.g. mLLDPE, LLDPE, or HDPE, is used in order to achieve at least limited recyclability.

One specific type of PE can be used in the substrate layer 4, but a mixture of various types of PE or various types of PE in the form of copolymers as well as in multiple layers can also be used. The term HDPE is understood to mean a type of PE with a density of between 0.94-0.97 g/cm³. Further possible PE types include, for example, low density linear polyethylene (LLDPE) (with a density of between 0.87-0.94 g/cm³), a low density polyethylene (LDPE) (with a density of between 0.915-0.935 g/cm³), or even a metallocene linear low density polyethylene (mLLDPE).

In an advantageous embodiment, mostly HDPE is used in the substrate layer 4, said layer having an HDPE content of at least 60 vol %, preferably 70 vol %, and particularly preferably at least 80 vol %. The remainder is a compatible polyolefin material that does not impair recyclability, for example as described above.

Additives are added in small quantities (at most 5 vol %), so they will not impair the recyclability of the packaging laminate 1.

The PE and the compatible polyolefin material can be present as a mixture in the substrate layer 4. However, the substrate layer 4 can also have a multiple layer structure (extruded or co-extruded) comprising one (or more than one) PE layer and one (or more than one) layer made of the compatible polyolefin material.

The thickness of the substrate layer 4 preferably measures from 5 to 35 μm.

A substrate layer 4 may, for example, be designed to comprise a central PE layer with two HDPE layers attached thereto, preferably an HDPE layer with a low mLLDPE or LLDPE content (e.g., 5 to 10 vol %) or corresponding layers made of mLLDPE or LLDPE. In such a symmetrical structure, the two external layers of the substrate layer 4 can be designed to be thicker than the internal layers, e.g., in the form of an x/1/x structure where x>1, in particular x=1.5, 2, 3, or 4.

The thermal stabilization layer 3 consists of ethyl-vinyl alcohol copolymer (EVOH) and has a thickness of not more than 10%, preferably not more than 5%, of the total thickness of the packaging laminate 1, which means, for example, not more than 3 to 10 μm for a typical laminate thickness of between 30 and 100 μm. However, the laminate thickness of the packaging laminate 1 can of course also be greater than 100 m, in which case the thickness of the thermal stabilization layer 3 would then be no greater than 10 μm. The recyclability of the packaging laminate 1 is not impaired as a result of the limited thickness of the thermal stabilization layer 3. EVOH with a PE content of maximum 50 mol %, preferably between 30 mol % and 50 mol %, is used for the thermal stabilization layer 3 in order to provide the thermal stabilization layer 3 with a sufficiently high melting point. Depending on the PE content of the EVOH a melting point of the EVOH of at least 155° C., preferably of at least 165° C., can be achieved. Despite the use of a barrier polymer, the thermal stabilization layer 3 only generates a partial barrier effect in the packaging laminate 1. Due to its limited thickness and its arrangement on the exterior of the packaging laminate 1, the barrier properties of the EVOH (in particular as a gas barrier, e.g. against oxygen) are significantly diminished by way of moisture, also as atmospheric humidity, during production and storage. As a result, the EVOH thermal stabilization layer 3 cannot alone provide the typical barrier properties required, so it cannot primarily be used as a barrier layer.

Preferably, only EVOH is used in the thermal stabilization layer 3. However, a mixture of EVOH and a limited content (not more than 20 vol %) of an ethylene (co)polymer can also be used.

The sealing layer 2 mainly consists of a PE material, in which case the PE content of the total polymer quantity of the sealing layer 2 (apart from any added mineral or other fillers or additives) should measure at least 80 vol %. In this context, various types of PE can be used—e.g. LDPE, LLDPE, MDPE, HDPE—as a single material, as a mixture, in the form of copolymers, or even in multiple layers. Depending on the application for the packaging laminate 1, the thickness of the sealing layer 2 typically measures between 20 and 100 μm. Of course, the remainder of the sealing layer 2 (apart from limited quantities of potential additives) will also consist of a polyolefin material (as described above) that is compatible in terms of the desired recyclability. The sealing layer 2 can also be designed to have multiple layers, e.g. extruded, co-extruded, or laminated.

The predominant use of PE and materials compatible therewith in the packaging laminate 1 enables the production of an especially recyclable laminate, which is able to be recycled in a straightforward and economical manner using conventional methods of mechanical recycling.

Moreover, it has surprisingly been determined that the thermal stability at sealing of the packaging laminate 1 can significantly be improved by the thermal stabilization layer 3 made of EVOH in spite of its very limited thickness of not more than 10%, preferably not more than 5% (absolutely not more than 10 μm), of the total thickness of the packaging laminate 1. Testing has shown that, when sealing the packaging laminate 1, the sealing jaw temperature can be significantly increased as a result of said improved thermal stability. When using an EVOH comprising 44 mol % PE, the sealing jaw temperature can be increased from, for example, a maximum of 130° C. to a maximum of 150° C. by using an HDPE in the external layer, and to at least 160° C. by using an EVOH comprising 32 mol % PE, whereby the external layer made of EVOH does not adhere to a sealing jaw, and no unsightly markings are left on the packaging laminate 1. The higher the melting point of the EVOH the higher the sealing jaw temperature can get. Given the fact that the barrier property need not be taken into consideration thereby, the content of PE in the EVOH can be optimized with respect to thermal stability. In this context, “sufficient thermal stability” means that sealing can take place at a certain sealing temperature without impairing the EVOH in the thermal stabilization layer 3. To this end, the melting point of the EVOH in particular must clearly be correspondingly high.

As illustrated in FIG. 2, a bonding layer 5 can also be arranged between the thermal stabilization layer 3 and the substrate layer 4 in order to optionally enhance the adhesive bonding between the thermal stabilization layer 3 and the substrate layer 4. The bonding layer 5 thus serves primarily to improve the adhesion between the thermal stabilization layer 3 and the substrate layer 4 in order to achieve sufficient adhesive bonding in the packaging laminate 1, in particular in order to reliably prevent undesired delamination of the thermal stabilization layer 3 and the substrate layer 4. The bonding layer 5 is also able to improve toughness. Suitable bonding layers 5 preferably consist of polymers with improved polarity, e.g. based on polymers that are compatible with polyethylenes in terms of recyclability characteristics, for example polyolefins modified with maleic acid anhydride (such as PE or PP), ethylene-vinyl acetate copolymers (EVA), ethylene/acrylic acid copolymers (EAA), ethylene butyl-acrylate copolymers (EBA), or similar polyolefin copolymers. The thickness of a bonding layer 5 typically measures from 1 to 5 μm.

As illustrated in FIG. 3, irrespective of the bonding layer 5 between the thermal stabilization layer 3 and the substrate layer 4, a barrier layer 6 can be provided in the packaging laminate 1 between the sealing layer 2 and the substrate layer 4. The barrier layer 6 preferably consists of a barrier polymer, hence a polymer with a sufficient barrier property, in particular against oxygen, hydrogen, and/or aroma. This barrier polymer is preferably a polyamide (PA) or an ethylene-vinyl alcohol copolymer (EVOH). EVOH is preferred as a barrier polymer. When using a barrier layer 6, it is important that the barrier layer 6 and the thermal stabilization layer 3 together constitute no more than 10%, preferably no more than 5%, of the total thickness of the packaging laminate 1 in order to ensure that the content of barrier polymer in the packaging laminate 1 is not so great that recyclability would be impaired. The barrier layer 6 itself has a thickness of not more than 10%, preferably 5%, of the total thickness of the packaging laminate 1, hence not more than 3 to 10 μm for a typical laminate thickness of between 30 and 100 μm. However, the combined thickness of the barrier layer 6 and the thermal stabilization layer 3 is independent of the total thickness of the packaging laminate 1, which in absolute terms is definitely not more than 10 μm. Recyclability is not impaired as a result of the limited thickness of the barrier layer 6.

In addition, a further suitable bonding layer may also be provided between the barrier layer 6 and the substrate layer 4 and/or between the barrier layer 6 and the sealing layer 2, for example designed as above, so as to enhance the adhesive bonding.

The packaging laminate 1 can, for example, be produced by means of co-extrusion. Preferably, the known blown film process or the flat film extrusion process will be used.

However, it is also possible for the thermal stabilization layer 3 and the substrate layer 4, as well as the bonding layer 5 optionally situated between the two, to be initially co-extruded into a first laminate layer 7 (e.g., FIG. 2). In the case of a bonding layer 5, the bonding may also take place by means of lamination or extrusion lamination with the bonding layer 5 acting as a laminating agent. Simultaneously the first laminate layer 7 may likewise be provided with a barrier layer 6 (e.g., FIG. 3). If a barrier layer 6 is provided, then it is particularly preferable for the result to be a symmetrical structure for the first laminate layer 7, for example comprising two externally situated EVOH layers in the laminate layer 7 with additional layers situated between these two, in which case the two EVOH layers can also have the same thickness. As a result of this symmetrical structure, the first laminate layer 7 has little or no tendency to curl, which simplifies the further processing of the laminate layer 7.

Said first laminate layer 7 could subsequently be bonded with the sealing layer 2, for example by using extrusion lamination or extrusion coating to bond the sealing layer 2 with the first laminate layer 7, or by means of adhesive lamination using a suitable laminating agent. In the case of lamination, the sealing layer 2 is bonded with the first laminate layer 7 by means of a suitable lamination adhesive, e.g. based on polyurethane adhesives or even polyolefin copolymers in case of extrusion lamination. The thickness of the lamination adhesive preferably measures from 2 to 5 g/m² for polyurethane-based adhesives, and from 5 to 20 g/m² for extrusion lamination.

If the first laminate layer 7 is provided with a barrier layer 6, then it is preferable for the first laminate layer 7 to be bonded with the sealing layer 2 within a very short period of time following production of said laminate layer 7, thereby limiting water absorption by the barrier layer 6. In some circumstances, it may even be necessary or practical to protect the film roll comprising the first laminate layer 7 from water absorption by means of suitable packaging until it is bonded with the sealing layer 2.

In addition, the first laminate layer 7 may be oriented in the machine direction (usually the longitudinal or the extrusion direction) before it is bonded with the sealing layer 2. The orientation ratio is preferably at least 4:1 in the machine direction. Said orientation can take place in-line (i.e., immediately following production of the laminate layer 7) or off-line (i.e., at a later point in time following said production). Unidirectional orientation can be performed in an easier and more economical manner than bidirectional orientation, thus enabling the reduction of production costs. However, the first laminate layer 7 may of course also be orientated bidirectionally.

It should be noted in this regard that, in the cases of blown film extrusion and flat film extrusion, the extrusion gap (from 1.5 to 2.5 mm with blown film), or rather the extrusion nozzle gap, is typically much larger than the final thickness of the extruded film (typically between 10 and 200 μm). The extruded melt is thereby elongated at temperatures well in excess of the melting point of the extruded polymer, as a result of which the melt will reach its final thickness. In the case of blown film extrusion, the melt is typically elongated in, for example, the transverse direction by a factor of about 2 to 3 (the so-called blow up ratio), and in the longitudinal direction by a factor of 1:10 to 1:100 (the so-called drawdown ratio). However, this elongation during extrusion cannot be compared to the orientation of a plastic foil since orientation conventionally takes place at temperatures just below the melting point of the polymer in order to permanently orient the disorganized polymers and the partly crystallized areas by means of the orientation process.

Said orientation also results in a high degree of transparency, mainly in the substrate layer 4. This orientation further results in barrier values for the barrier layer 6 being increased to about three to four times compared to that of not orientated barrier polymer of the same type, thus enabling the use of a less expensive barrier polymer having the same barrier performance. As a further result, the cost of the first laminate layer 7, hence also that of the packaging laminate 1, can be significantly reduced.

The first laminate layer 7 is preferably produced using the blown film extrusion process since less production-related edge trim is generated thereby, which, particularly given the expense of barrier polymers, will result in lower costs for the packaging laminate 1. In the case of blown film extrusion, more viscous HDPE materials having an MFI (Mass Flow Index) of less than 3 can also be used. HDPE materials of this kind have a higher molecular weight as well as better mechanical properties and are thus beneficial for use in a packaging laminate 1.

It is furthermore possible for the barrier layer 6 to be metallized on the side facing the sealing layer 6 in order to enhance barrier performance and/or to be coated (for example with aluminum oxide or silicon oxide) in order to enhance barrier performance and/or adhesion before the first laminate layer 7 is bonded with the sealing layer 2. Aluminum is preferably used in the metallizing process. The barrier layer 6 and/or the substrate layer 4 may also be imprinted, and pre-treatment of the surfaces to be imprinted, for example a corona treatment or a flame treatment, can also be performed in order to improve the adhesion of the imprinted layer to the barrier layer 6 and/or the substrate layer 4. Conventional printing methods can be used in this context, for example an intaglio printing process or a flexo printing process. Further treatment of this kind will obviously take place after any orientation process.

The barrier performance of the packaging laminate 1 can be further enhanced by using a barrier lacquer, for example polyvinyl alcohol (PVOH), to imprint at least one layer of the first laminate layer 7, or also the side of the sealing layer 2 facing the first laminate layer 7. Lacquer layers of this kind can be applied quite thinly, typically in the range from 0.5 to 2.0 g/m², so the recyclability of the packaging laminate 1 is not thus impaired.

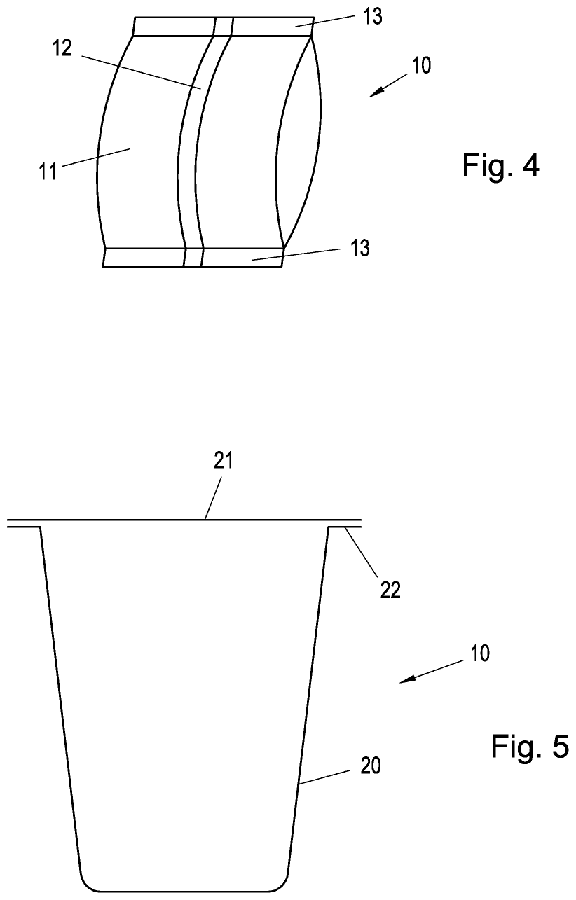

The packaging laminate 1 according to the present teaching is normally used to produce packaging that is, for example, utilized for food products. To this end, the packaging laminate 1 can be cut to size and shaped for packaging 10, for example by means of folding and sealing, which is illustrated in FIG. 4 for the example of a pouch 11 comprising a longitudinal seal 12 and two transverse seals 13. However, the packaging laminate 1 can also be processed outright in known continuous packaging machines, e.g. so-called form fill machines or tubular bag machines. In the sealing process, the sealing point of the folded packaging laminate 1 is compressed in a known manner between two temperature-controlled sealing jaws. The thermal stabilization layer 3 of the packaging laminate 1 faces the sealing jaws. However, as shown in FIG. 5, blank lids 21 for closing containers 20 used as packaging 10 can also be punched from the packaging laminate 1. In any event, the sealing takes place at the sealing layer 2 of the packaging laminate 1 either against the sealing layer itself (e.g., for folded packaging like pouches, bags, or sacks) or against another sealing layer (e.g., on a sealing edge 22 of a container 20). The sealing layer 2 thereby faces the packaged product inside the finished packaging, and the thermal stabilization layer 3 is situated externally.

1. A method for producing a packaging laminate in which an externally arranged sealing layer comprising a polyethylene content of at least 80 vol % is bonded with a substrate layer having a polyethylene content of at least 60 vol % and with a thermal stabilization layer, wherein the thermal stabilization layer is arranged externally opposite the sealing layer, and the substrate layer is arranged between the sealing layer and the thermal stabilization layer, wherein the thermal stabilization layer is produced from ethylene-vinyl alcohol copolymer, and the thickness of the thermal stabilization layer constitutes up to 10% of the total thickness of the packaging laminate, but no more than 10 μm.

2. The method according to claim 1, wherein an ethylene-vinyl alcohol copolymer with a polyethylene content of maximum 50 mol % is used.

3. The method according to claim 1, wherein a barrier layer made of ethylene-vinyl alcohol copolymer or polyamide is arranged between the sealing layer and the substrate layer, wherein the thickness of the thermal stabilization layer and the thickness of the barrier layer together constitute no more than 5% of the total thickness of the packaging laminate, but no more than 10 μm.

4. The method according to claim 1, wherein a bonding layer is arranged between the substrate layer and the thermal stabilization layer.

5. The method according to claim 1, wherein the individual layers of the packaging laminate are co-extruded.

6. The method according to claim 1, wherein the substrate layer and the thermal stabilization layer, or the substrate layer, the bonding layer and the thermal stabilization layer, are co-extruded and subsequently bonded with the sealing layer.

7. The method according to claim 6, wherein the co-extruded substrate layer and thermal stabilization layer, or the co-extruded substrate layer, bonding layer and thermal stabilization layer, are oriented in the machine direction and/or in the transverse direction before they are bonded with the sealing layer.

8. The method according to claim 3, wherein the barrier layer, the substrate layer and the thermal stabilization layer, or the barrier layer, the substrate layer, the bonding layer and the thermal stabilization layer, are co-extruded and subsequently bonded with the sealing layer.

9. The method according to claim 8, wherein the co-extruded barrier layer, substrate layer and thermal stabilization layer, or the co-extruded barrier layer, substrate layer, bonding layer and thermal stabilization layer, are oriented in the machine direction and/or in the transverse direction before they are bonded with the sealing layer.

10. The method according to claim 3, wherein the barrier layer is metallized or coated.

11. A packaging laminate with an externally oriented sealing layer comprising a polyethylene content of at least 80 vol %, which is bonded with a substrate layer having a polyethylene content of at least 60 vol % and with a thermal stabilization layer, wherein the thermal stabilization layer is arranged externally opposite to the sealing layer, and the substrate layer is arranged between the sealing layer and the thermal stabilization layer, wherein the thermal stabilization layer is produced from ethylene-vinyl alcohol copolymer, and the thickness of the thermal stabilization layer constitutes up to 10% of the total thickness of the packaging laminate, but no more than 10 μm.

12. The packaging laminate according to claim 11, wherein the thermal stabilization layer is produced from ethylene-vinyl alcohol copolymer with a polyethylene content of maximum 50 mol %.

13. The packaging laminate according to claim 11, wherein a barrier layer made of ethylene-vinyl alcohol copolymer or polyamide is arranged between the sealing layer and the substrate layer, wherein the thickness of the thermal stabilization layer and the thickness barrier layer together constitute no more than 10% of the total thickness of the packaging laminate, but no more than 10 μm.

14. The packaging laminate according to claim 13, wherein the barrier layer is metallized or coated.

15. The packaging laminate according to claim 11, wherein a bonding layer is arranged between the substrate layer and the thermal stabilization layer.

16. The method according to claim 1, wherein the substrate layer has a polyethylene content of at least 80 vol %.

17. The method according to claim 1, wherein the thickness of the thermal stabilization layer constitutes up to 5% of the total thickness of the packaging laminate.

18. The method according to claim 2, wherein the ethylene-vinyl alcohol copolymer has a polyethylene content between 30 mol % and 50 mol %.
